(19) United States
(12) Patent Application Publication
(10) Pub. No.: US 2022/0103516 A1
(43) Pub. Date: Mar. 31, 2022

(54) SECURE ENCRYPTED COMMUNICATION MECHANISM

(71) Applicant: Intel Corporation, Santa Clara, CA (US)

(72) Inventors: Pradeep Pappachan, Tualatin, OR (US); Luis Kida, Beaverton, OR (US); Donald E. Wood, Austin, TX (US); Tony Hurson, Austin, TX (US); Reouven Elbaz, Hillsboro, OR (US); Reshma Lal, Portland, OR (US)

(73) Assignee: Intel Corporation, Santa Clara, CA (US)

(21) Appl. No.: 17/547,655

(22) Filed: Dec. 10, 2021

(51) Int. Cl. H04L 9/30; G06F 9/455

(52) U.S. Cl. CPC H04L 63/029; G06F 9/45558; H04L 63/164; G06F 2009/45595; G06F 2009/45587

(57) ABSTRACT

An apparatus comprising a first computing platform including a processor to execute a first trusted executed environment (TEE) to host a first plurality of virtual machines and a first network interface controller to establish a trusted communication channel with a second computing platform via an orchestration controller.

### BACKGROUND

In cloud datacenters, Cloud service providers (CSPs) enable users to set up Virtual Cloud Networks (VCN) that can be controlled, while using shared physical infrastructure. VCNs allow users to assign private IP address spaces, create their own subnets, define routing tables, and configure firewalls. This is accomplished by creating an overlay network by using a tunneling protocol, such as a Virtual Extensible local area network (VXLAN), that encapsulates Layer 2 frames in Layer 3 UDP packets that are routed over a physical underlay network. While overlay virtual networks isolate network traffic from different users, it does not protect the confidentiality and integrity of the data as it travels on the untrusted physical network.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a computing device for secure I/O with an accelerator device;

FIG. 2 is a simplified block diagram of at least one embodiment of an accelerator device of the computing device of FIG. 1;

FIG. 3 is a simplified block diagram of at least one embodiment of an environment of the computing device of FIGS. 1 and 2;

FIG. 4 illustrates a computing device according to implementations of the disclosure;

FIG. 5 illustrates a conventional overlay network;

FIG. 6 illustrates one embodiment of a platform;

FIGS. 7A & 7B illustrate embodiments of platforms in a network;

FIG. 8 is a flow diagram illustrating one embodiment of establishing a secure encrypted communication channel between platforms;

FIG. 9 is a sequence diagram illustrating one embodiment of a process establishing a key exchange between machines; and

FIG. 10 illustrates one embodiment of a schematic diagram of an illustrative electronic computing device.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

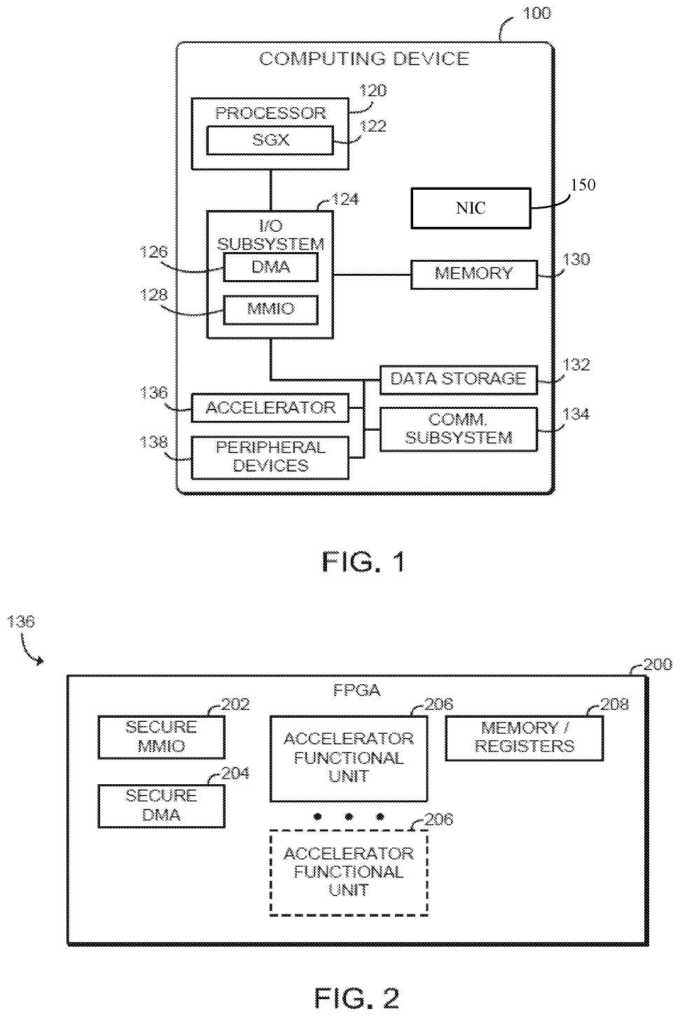

Referring now to FIG. 1, a computing device 100 for secure I/O with an accelerator device includes a processor 120 and an accelerator device 136, such as a field-programmable gate array (FPGA). In use, as described further below, a trusted execution environment (TEE) established by the processor 120 securely communicates data with the accelerator 136. Data may be transferred using memory-mapped I/O (MMIO) transactions or direct memory access (DMA) transactions. For example, the TEE may perform an MMIO write transaction that includes encrypted data, and the accelerator 136 decrypts the data and performs the write. As another example, the TEE may perform an MMIO read request transaction, and the accelerator 136 may read the requested data, encrypt the data, and perform an MMIO read response transaction that includes the encrypted data. As yet another example, the TEE may configure the accelerator 136 to perform a DMA operation, and the accelerator 136 performs a memory transfer, performs a cryptographic operation (i.e., encryption or decryption), and forwards the result. As described further below, the TEE and the accelerator 136 generate authentication tags (ATs) for the transferred data and may use those ATs to validate the transactions. The computing device 100 may thus keep untrusted software of the computing device 100, such as the operating system or virtual machine monitor, outside of the trusted code base (TCB) of the TEE and the accelerator 136. Thus, the computing device 100 may secure data exchanged or otherwise processed by a TEE and an accelerator 136 from an owner of the computing device 100 (e.g., a cloud service provider) or other tenants of the computing device 100. Accordingly, the computing device 100 may improve security and performance for multi-tenant environments by allowing secure use of accelerator devices.

The computing device 100 may be embodied as any type of device capable of performing the functions described herein. For example, the computing device 100 may be embodied as, without limitation, a computer, a laptop computer, a tablet computer, a notebook computer, a mobile computing device, a smartphone, a wearable computing device, a multiprocessor system, a server, a workstation, and/or a consumer electronic device. As shown in FIG. 1, the illustrative computing device 100 includes a processor 120, an I/O subsystem 124, a memory 130, and a data storage device 132. Additionally, in some embodiments, one or more of the illustrative components may be incorporated in, or otherwise form a portion of, another component. For example, the memory 130, or portions thereof, may be incorporated in the processor 120 in some embodiments.

The processor 120 may be embodied as any type of processor capable of performing the functions described herein. For example, the processor 120 may be embodied as a single or multi-core processor(s), digital signal processor, microcontroller, or other processor or processing/controlling circuit. As shown, the processor 120 illustratively includes secure enclave support 122, which allows the processor 120 to establish a trusted execution environment known as a secure enclave, in which executing code may be measured, verified, and/or otherwise determined to be authentic. Additionally, code and data included in the secure enclave may be encrypted or otherwise protected from being accessed by code executing outside of the secure enclave. For example, code and data included in the secure enclave may be protected by hardware protection mechanisms of the processor 120 while being executed or while being stored in certain protected cache memory of the processor 120. The code and data included in the secure enclave may be encrypted when stored in a shared cache or the main memory 130. The secure enclave support 122 may be embodied as a set of processor instruction extensions that allows the processor 120 to establish one or more secure enclaves in the memory 130. For example, the secure enclave support 122 may be embodied as Intel® Software Guard Extensions (SGX) technology. In other embodiments, the secure enclave support 122 may be utilized by Intel® Trusted Domain Extensions (TDX) technology that is implemented to isolate virtual machines from the virtual machine monitor and other virtual machines operating on the computing device 100.

The memory 130 may be embodied as any type of volatile or non-volatile memory or data storage capable of performing the functions described herein. In operation, the memory 130 may store various data and software used during operation of the computing device 100 such as operating systems, applications, programs, libraries, and drivers. As shown, the memory 130 may be communicatively coupled to the processor 120 via the I/O subsystem 124, which may be embodied as circuitry and/or components to facilitate input/output operations with the processor 120, the memory 130, and other components of the computing device 100. For example, the I/O subsystem 124 may be embodied as, or otherwise include, memory controller hubs, input/output control hubs, sensor hubs, host controllers, firmware devices, communication links (i.e., point-to-point links, bus links, wires, cables, light guides, printed circuit board traces, etc.) and/or other components and subsystems to facilitate the input/output operations. In some embodiments, the memory 130 may be directly coupled to the processor 120, for example via an integrated memory controller hub. Additionally, in some embodiments, the I/O subsystem 124 may form a portion of a system-on-a-chip (SoC) and be incorporated, along with the processor 120, the memory 130, the accelerator device 136, and/or other components of the computing device 100, on a single integrated circuit chip. Additionally, or alternatively, in some embodiments the processor 120 may include an integrated memory controller and a system agent, which may be embodied as a logic block in which data traffic from processor cores and I/O devices converges before being sent to the memory 130.

As shown, the I/O subsystem 124 includes a direct memory access (DMA) engine 126 and a memory-mapped I/O (MMIO) engine 128. The processor 120, including secure enclaves established with the secure enclave support 122, may communicate with the accelerator device 136 with one or more DMA transactions using the DMA engine 126 and/or with one or more MMIO transactions using the MMIO engine 128. The computing device 100 may include multiple DMA engines 126 and/or MMIO engines 128 for handling DMA and MMIO read/write transactions based on bandwidth between the processor 120 and the accelerator 136. Although illustrated as being included in the I/O subsystem 124, it should be understood that in some embodiments the DMA engine 126 and/or the MMIO engine 128 may be included in other components of the computing device 100 (e.g., the processor 120, memory controller, or system agent), or in some embodiments may be embodied as separate components.

The data storage device 132 may be embodied as any type of device or devices configured for short-term or long-term storage of data such as, for example, memory devices and circuits, memory cards, hard disk drives, solid-state drives, non-volatile flash memory, or other data storage devices. The computing device 100 may also include a communications subsystem 134, which may be embodied as any communication circuit, device, or collection thereof, capable of enabling communications between the computing device 100 and other remote devices over a computer network (not shown). The communications subsystem 134 may be configured to use any one or more communication technology (e.g., wired or wireless communications) and associated protocols (e.g., Ethernet, Bluetooth®, Wi-Fi®, WiMAX, 3G, 4G LTE, etc.) to effect such communication.

The accelerator device 136 may be embodied as a field-programmable gate array (FPGA), an application-specific integrated circuit (ASIC), a coprocessor, or other digital logic device capable of performing accelerated functions (e.g., accelerated application functions, accelerated network functions, or other accelerated functions), GPUs, etc. Illustratively, the accelerator device 136 is an FPGA, which may be embodied as an integrated circuit including programmable digital logic resources that may be configured after manufacture. The FPGA may include, for example, a configurable array of logic blocks in communication over a configurable data interchange. The accelerator device 136 may be coupled to the processor 120 via a high-speed connection interface such as a peripheral bus (e.g., a PCI Express bus) or an inter-processor interconnect (e.g., an in-die interconnect (IDI) or QuickPath Interconnect (QPI)), or via any other appropriate interconnect. The accelerator device 136 may receive data and/or commands for processing from the processor 120 and return results data to the processor 120 via DMA, MMIO, or other data transfer transactions.

As shown, the computing device 100 may further include one or more peripheral devices 138. The peripheral devices 138 may include any number of additional input/output devices, interface devices, hardware accelerators, and/or other peripheral devices. For example, in some embodiments, the peripheral devices 138 may include a touch screen, graphics circuitry, a graphical processing unit (GPU) and/or processor graphics, an audio device, a microphone, a camera, a keyboard, a mouse, a network interface, and/or other input/output devices, interface devices, and/or peripheral devices.

The computing device 100 may also include a network interface controller (NIC) 150. NIC 150 enables computing device 100 to communicate with another computing device 100 via a network. In embodiments, NIC 150 may comprise a programmable (or smart) NIC, infrastructure processing unit (IPU), or datacenter processing unit (DPU) that may be configured to perform different actions based on a type of packet, connection, or other packet characteristic.

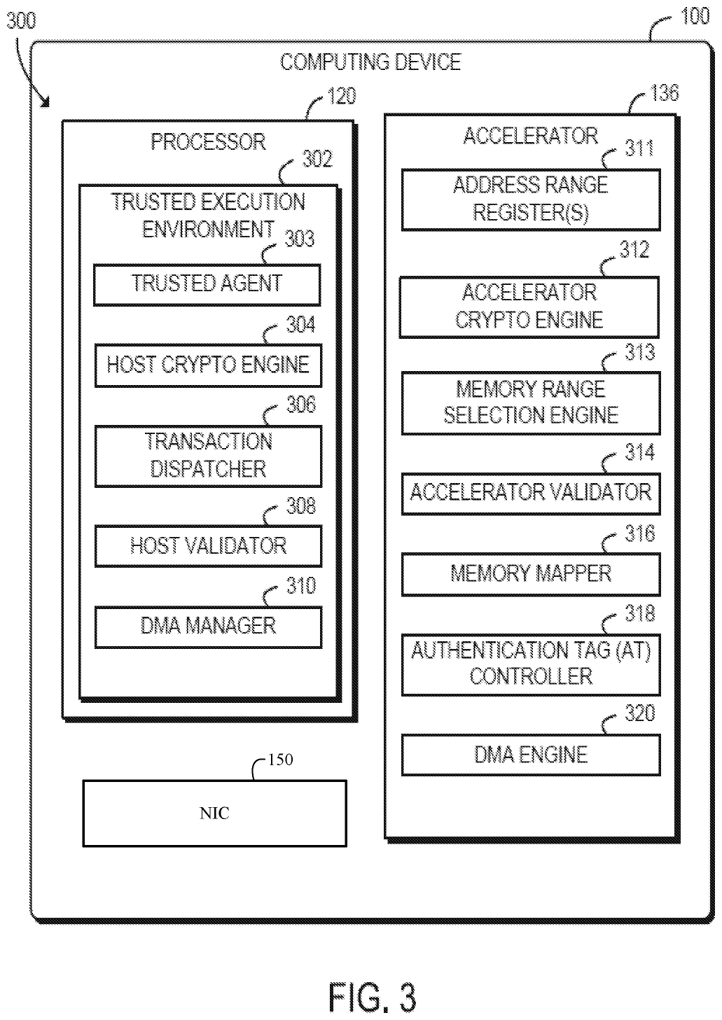

Referring now to FIG. 2, an illustrative embodiment of a field-programmable gate array (FPGA) 200 is shown. As shown, the FPGA 200 is one potential embodiment of an accelerator device 136. The illustratively FPGA 200 includes a secure MMIO engine 202, a secure DMA engine 204, one or more accelerator functional units (AFUs) 206, and memory/registers 208. As described further below, the secure MMIO engine 202 and the secure DMA engine 204 perform in-line authenticated cryptographic operations on data transferred between the processor 120 (e.g., a secure enclave established by the processor) and the FPGA 200 (e.g., one or more AFUs 206). In some embodiments, the secure MMIO engine 202 and/or the secure DMA engine 204 may intercept, filter, or otherwise process data traffic on one or more cache-coherent interconnects, internal buses, or other interconnects of the FPGA 200.

Each AFU 206 may be embodied as logic resources of the FPGA 200 that are configured to perform an acceleration task. Each AFU 206 may be associated with an application executed by the computing device 100 in a secure enclave or other trusted execution environment. Each AFU 206 may be configured or otherwise supplied by a tenant or other user of the computing device 100. For example, each AFU 206 may correspond to a bitstream image programmed to the FPGA 200. As described further below, data processed by each AFU 206, including data exchanged with the trusted execution environment, may be cryptographically protected from untrusted components of the computing device 100 (e.g., protected from software outside of the trusted code base of the tenant enclave). Each AFU 206 may access or otherwise process stored in the memory/registers 208, which may be embodied as internal registers, cache, SRAM, storage, or other memory of the FPGA 200. In some embodiments, the memory 208 may also include external DRAM or other dedicated memory coupled to the FPGA 200.

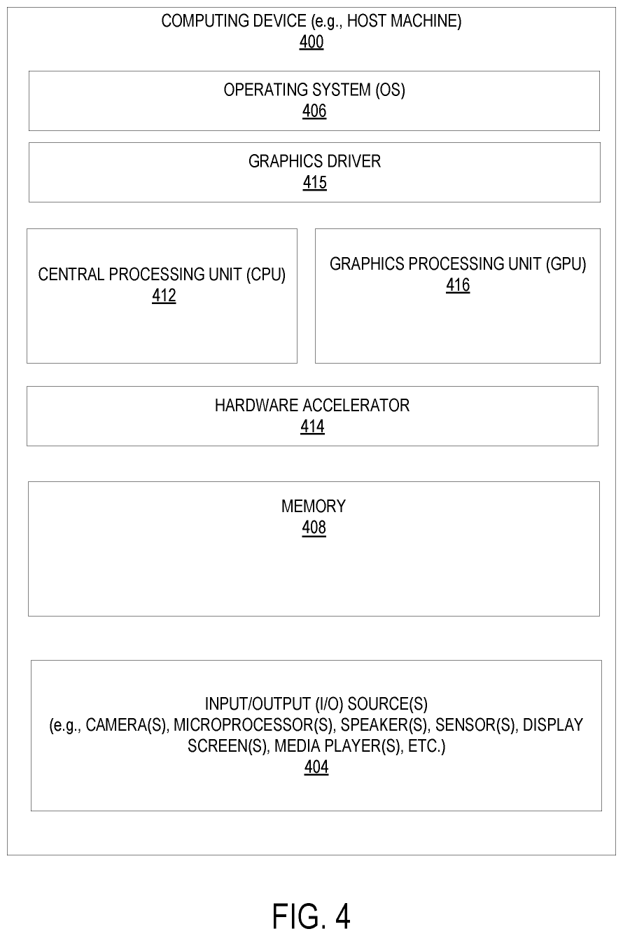

Referring now to FIG. 3, in an illustrative embodiment, the computing device 100 establishes an environment 300 during operation. The illustrative environment 300 includes a trusted execution environment (TEE) 302 and the accelerator 136. The TEE 302 further includes a trusted agent 303, host cryptographic engine 304, a transaction dispatcher 306, a host validator 308, and a direct memory access (DMA) manager 310. The accelerator 136 includes an accelerator cryptographic engine 312, a memory range selection engine 313, an accelerator validator 314, a memory mapper 316, an authentication tag (AT) controller 318, and a DMA engine 320. The various components of the environment 300 may be embodied as hardware, firmware, software, or a combination thereof. As such, in some embodiments, one or more of the components of the environment 300 may be embodied as circuitry or collection of electrical devices (e.g., host cryptographic engine circuitry 304, transaction dispatcher circuitry 306, host validator circuitry 308, DMA manager circuitry 310, accelerator cryptographic engine circuitry 312, accelerator validator circuitry 314, memory mapper circuitry 316, AT controller circuitry 318, and/or DMA engine circuitry 320). It should be appreciated that, in such embodiments, one or more of the host cryptographic engine circuitry 304, the transaction dispatcher circuitry 306, the host validator circuitry 308, the DMA manager circuitry 310, the accelerator cryptographic engine circuitry 312, the accelerator validator circuitry 314, the memory mapper circuitry 316, the AT controller circuitry 318, and/or the DMA engine circuitry 320 may form a portion of the processor 120, the I/O subsystem 124, the accelerator 136, and/or other components of the computing device 100. Additionally, in some embodiments, one or more of the illustrative components may form a portion of another component and/or one or more of the illustrative components may be independent of one another.

The TEE 302 may be embodied as a trusted execution environment of the computing device 100 that is authenticated and protected from unauthorized access using hardware support of the computing device 100, such as the secure enclave support 122 of the processor 120. Illustratively, the TEE 302 may be embodied as one or more secure enclaves established using Intel SGX technology and utilized by TDX technology. The TEE 302 may also include or otherwise interface with one or more drivers, libraries, or other components of the computing device 100 to interface with the accelerator 136.

The host cryptographic engine 304 is configured to generate an authentication tag (AT) based on a memory-mapped I/O (MMIO) transaction and to write that AT to an AT register of the accelerator 136. For an MMIO write request, the host cryptographic engine 304 is further configured to encrypt a data item to generate an encrypted data item, and the AT is generated in response to encrypting the data item. For an MMIO read request, the AT is generated based on an address associated with MMIO read request.

The transaction dispatcher 306 is configured to dispatch the memory-mapped I/O transaction (e.g., an MMIO write request or an MMIO read request) to the accelerator 136 after writing the calculated AT to the AT register. An MMIO write request may be dispatched with the encrypted data item.

The host validator 308 may be configured to verify that an MMIO write request succeeded in response dispatching the MMIO write request. Verifying that the MMIO write request succeeded may include securely reading a status register of the accelerator 136, securely reading a value at the address of the MMIO write from the accelerator 136, or reading an AT register of the accelerator 136 that returns an AT value calculated by the accelerator 136, as described below. For MMIO read requests, the host validator 308 may be further configured to generate an AT based on an encrypted data item included in a MMIO read response dispatched from the accelerator 136; read a reported AT from a register of the accelerator 136; and determine whether the AT generated by the TEE 302 matches the AT reported by the accelerator 136. The host validator 308 may be further configured to indicate an error if those ATs do not match, which provides assurance that data was not modified on the way from the TEE 302 to the accelerator 136.

The accelerator cryptographic engine 312 is configured to perform a cryptographic operation associated with the MMIO transaction and to generate an AT based on the MMIO transaction in response to the MMIO transaction being dispatched. For an MMIO write request, the cryptographic operation includes decrypting an encrypted data item received from the TEE 302 to generate a data item, and the AT is generated based on the encrypted data item. For an MMIO read request, the cryptographic operation includes encrypting a data item from a memory of the accelerator 136 to generate an encrypted data item, and the AT is generated based on that encrypted data item.

The accelerator validator 314 is configured to determine whether the AT written by the TEE 302 matches the AT determined by the accelerator 136. The accelerator validator 314 is further configured to drop the MMIO transaction if those ATs do not match. For MMIO read requests, the accelerator validator 314 may be configured to generate a poisoned AT in response to dropping the MMIO read request, and may be further configured to dispatch a MMIO read response with a poisoned data item to the TEE 302 in response to dropping the MMIO read request.

The memory mapper 316 is configured to commit the MMIO transaction in response to determining that the AT written by the TEE 302 matches the AT generated by the accelerator 136. For an MMIO write request, committing the transaction may include storing the data item in a memory of the accelerator 136. The memory mapper 316 may be further configured to set a status register to indicate success in response to storing the data item. For an MMIO read request, committing the transaction may include reading the data item at the address in the memory of the accelerator 136 and dispatching an MMIO read response with the encrypted data item to the TEE 302.

The DMA manager 310 is configured to securely write an initialization command to the accelerator 136 to initialize a secure DMA transfer. The DMA manager 310 is further configured to securely configure a descriptor indicative of a host memory buffer, an accelerator 136 buffer, and a transfer direction. The transfer direction may be host to accelerator 136 or accelerator 136 to host. The DMA manager 310 is further configured to securely write a finalization command to the accelerator 136 to finalize an authentication tag (AT) for the secure DMA transfer. The initialization command, the descriptor, and the finalization command may each be securely written and/or configured with an MMIO write request. The DMA manager 310 may be further configured to determine whether to transfer additional data in response to securely configuring the descriptor, the finalization command may be securely written in response to determining that no additional data remains for transfer.

The AT controller 318 is configured to initialize an AT in response to the initialization command from the TEE 302. The AT controller 318 is further configured to finalize the AT in response to the finalization command from the TEE 302.

The DMA engine 320 is configured to transfer data between the host memory buffer and the accelerator 136 buffer in response to the descriptor from the TEE 302. For a transfer from host to accelerator 136, transferring the data includes copying encrypted data from the host memory buffer and forwarding the plaintext data to the accelerator 136 buffer in response to decrypting the encrypted data. For a transfer from accelerator 136 to host, transferring the data includes copying plaintext data from the accelerator 136 buffer and forwarding encrypted data to the host memory buffer in response encrypting the plaintext data.

The accelerator cryptographic engine 312 is configured to perform a cryptographic operation with the data in response to transferring the data and to update the AT in response to transferring the data. For a transfer from host to accelerator 136, performing the cryptographic operation includes decrypting encrypted data to generate plaintext data. For a transfer from accelerator 136 to host, performing the cryptographic operation includes encrypting plaintext data to generate encrypted data.

The host validator 308 is configured to determine an expected AT based on the secure DMA transfer, to read the AT from the accelerator 136 in response to securely writing the finalization command, and to determine whether the AT from the accelerator 136 matches the expected AT. The host validator 308 may be further configured to indicate success if the ATs match and to indicate failure if the ATs do not match.

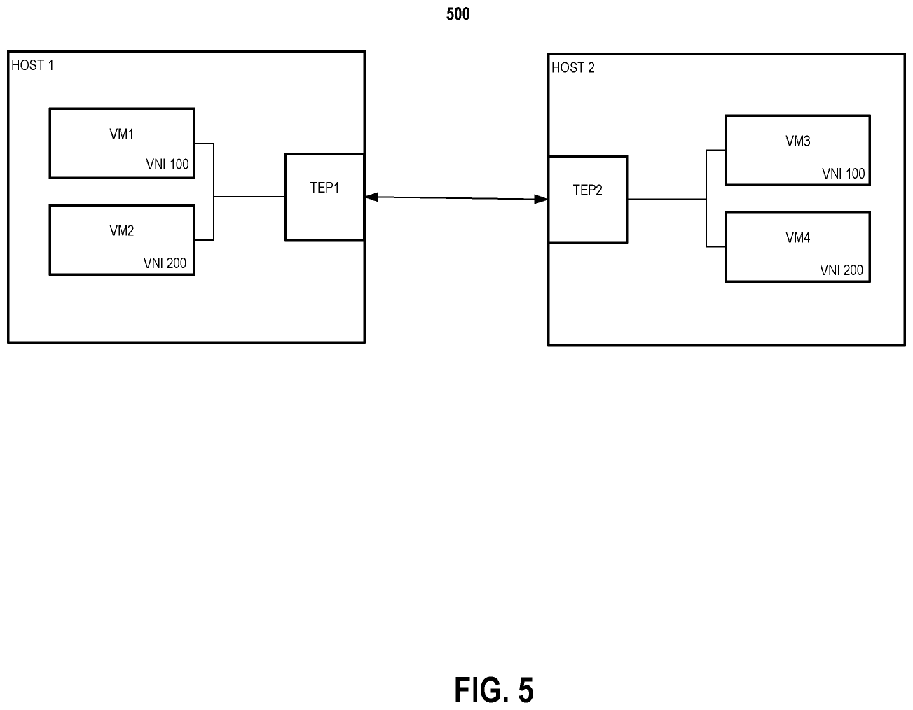

FIG. 4 illustrates another embodiment of a computing device 400. Computing device 400 represents a communication and data processing device including or representing (without limitations) smart voice command devices, intelligent personal assistants, home/office automation system, home appliances (e.g., washing machines, television sets, etc.), mobile devices (e.g., smartphones, tablet computers, etc.), gaming devices, handheld devices, wearable devices (e.g., smartwatches, smart bracelets, etc.), virtual reality (VR) devices, head-mounted display (HMDs), Internet of Things (IoT) devices, laptop computers, desktop computers, server computers, set-top boxes (e.g., Internet based cable television set-top boxes, etc.), global positioning system (GPS)—based devices, automotive infotainment devices, etc.

In some embodiments, computing device 400 includes or works with or is embedded in or facilitates any number and type of other smart devices, such as (without limitation) autonomous machines or artificially intelligent agents, such as a mechanical agents or machines, electronics agents or machines, virtual agents or machines, electromechanical agents or machines, etc. Examples of autonomous machines or artificially intelligent agents may include (without limitation) robots, autonomous vehicles (e.g., self-driving cars, self-flying planes, self-sailing boats, etc.), autonomous equipment self-operating construction vehicles, self-operating medical equipment, etc.), and/or the like. Further, “autonomous vehicles” are not limed to automobiles but that they may include any number and type of autonomous machines, such as robots, autonomous equipment, household autonomous devices, and/or the like, and any one or more tasks or operations relating to such autonomous machines may be interchangeably referenced with autonomous driving.

Further, for example, computing device 400 may include a computer platform hosting an integrated circuit (“IC”), such as a system on a chip (“SOC” or “SOC”) , integrating various hardware and/or software components of computing device 400 on a single chip.

As illustrated, in one embodiment, computing device 400 may include any number and type of hardware and/or software components, such as (without limitation) graphics processing unit (“GPU” or simply “graphics processor”) 416, graphics driver (also referred to as “GPU driver”, “graphics driver logic”, “driver logic”, user-mode driver (UMD), user-mode driver framework (UMDF), or simply “driver”) 415, central processing unit (“CPU” or simply “application processor”) 412, hardware accelerator 414 (such as an FPGA, ASIC, a re-purposed CPU, or a re-purposed GPU, for example), memory 408, network devices, drivers, or the like, as well as input/output (I/O) sources 404, such as touchscreens, touch panels, touch pads, virtual or regular keyboards, virtual or regular mice, ports, connectors, etc. Computing device 400 may include operating system (OS) 406 serving as an interface between hardware and/or physical resources of the computing device 400 and a user.

It is to be appreciated that a lesser or more equipped system than the example described above may be utilized for certain implementations. Therefore, the configuration of computing device 400 may vary from implementation to implementation depending upon numerous factors, such as price constraints, performance requirements, technological improvements, or other circumstances.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The terms “logic”, “module”, “component”, “engine”, “circuitry”, “element”, and “mechanism” may include, by way of example, software, hardware and/or a combination thereof , such as firmware.

Computing device 400 may host network interface device(s) to provide access to a network, such as a LAN, a wide area network (WAN), a metropolitan area network (MAN), a personal area network (PAN) , Bluetooth , a cloud network, a mobile network (e.g., 3rd Generation (3G), 4th Generation (4G), etc.), an intranet, the Internet, etc. Network interface(s) may include, for example, a wireless network interface having antenna, which may represent one or more antenna(s). Network interface(s) may also include, for example, a wired network interface to communicate with remote devices via network cable, which may be, for example, an Ethernet cable, a coaxial cable, a fiber optic cable, a serial cable, or a parallel cable.

Embodiments may be provided, for example, as a computer program product which may include one or more machine-readable media having stored thereon machine executable instructions that, when executed by one or more machines such as a computer, network of computers, or other electronic devices, may result in the one or more machines carrying out operations in accordance with embodiments described herein. A machine-readable medium may include, but is not limited to, floppy diskettes , optical disks, CD-ROMs (Compact Disc-Read Only Memories), and magneto-optical disks, ROMs, RAMS, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

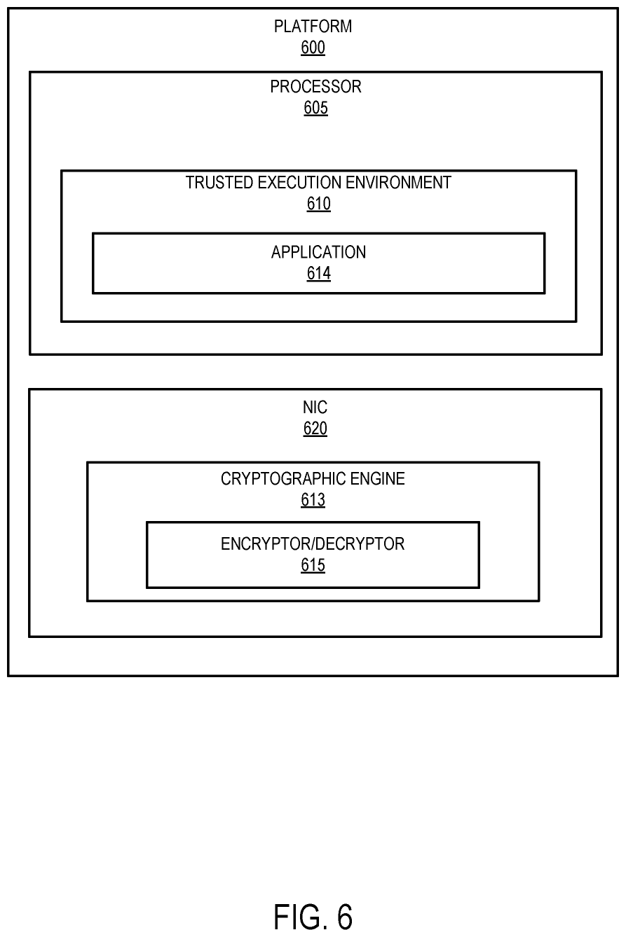

FIG. 5 illustrates an exemplary overlay network 500. As used herein, an overlay network is a virtual network that is built on top of underlying network infrastructure (Underlay Network), while an underlay network is physical infrastructure above which overlay network is built (e.g., the underlying network responsible for delivery of packets across networks). As a result, the underlay network provides a service to the overlay network. As shown in FIG. 5, the network 500 includes two hosts (Host 1 and Host 2), each hosting two virtual machines (VMs), VMs 1 and 2 within host 1 and VMs 3 and 4 within host 2. In one embodiment, VMs 1 and 3 may be included in one virtual network, while VMs 2 and 4 may be included in another virtual network. In a further embodiment, each VM has a virtual Ethernet and IP addresses. However, VMs on different virtual networks may have the same IP address. Each virtual network may be identified by a unique Virtual Extensible local area network (VXLAN) Network ID (VNI). For example, the virtual network for VMs 1 and 3 may have a VNI of 100, whereas VMs 2 and 4 may be on a virtual network identified by a VNI of 200. Additionally, hosts 1 and 2 each include a tunneling endpoint (TEP) to translate between destination virtual Ethernet addresses/VNI on the virtual overlay network to an IP address on the physical underlay network.

In an instance in which VM1 is to communicate with VM3, VM1 creates an Ethernet frame with a destination MAC address associated with VM3. TEP1 translates the destination MAC address to the IP address of host 2. A VXLAN encapsulation header includes this “outer” IP address. The original Ethernet frame is encapsulated in a UDP/IP/VXLAN packet. When this packet reaches host 2, the outer VXLAN/IP/UDP headers are stripped off and the inner Ethernet frame is delivered to VM3.

As shown above, the overlay network isolates network traffic from different VMs, but do not protect the confidentiality and integrity of the data transmitted via an untrusted physical network. Upper-level security protocols (e.g., Transport Layer Security (TLS) and Internet Protocol Security (IPsec)) are typically implemented to protect the confidentiality and integrity of the data. Typically, CSPs establish IPsec channels between physical machines that host guest VMs, thus protecting the packets on the physical network up to Layer 3. However, for confidential computing, a CSP is not trusted, and will therefore need to perform their own encryption that a user controls. This user-controlled encryption may be performed using TLS or IPsec on encapsulated packets within the VM.

However, IPsec encryption must be performed twice (e.g., at both the outer and inner L3 packet levels). Additionally, every pair of VMs needs a unique IPsec Security Association (SA), which represents significant overhead in memory and management when considering that each host may include. For example, each VM within a host includes its own encryption key to encrypt messages via the IPsec SA protocol. Since each host may include thousands of VMs the host is required to store and manage thousands of encryption keys.

According to one embodiment, a mechanism is disclosed to protect data transmitted from a plurality of VMs within a first host to a plurality of VMs within a second host via a shared IPsec channel between the two physical hosts. In such an embodiment, a trusted network interface card is implemented to transfer the data between the hosts without including the CSP in the Trusted Compute Base (TCB) of the VMs.

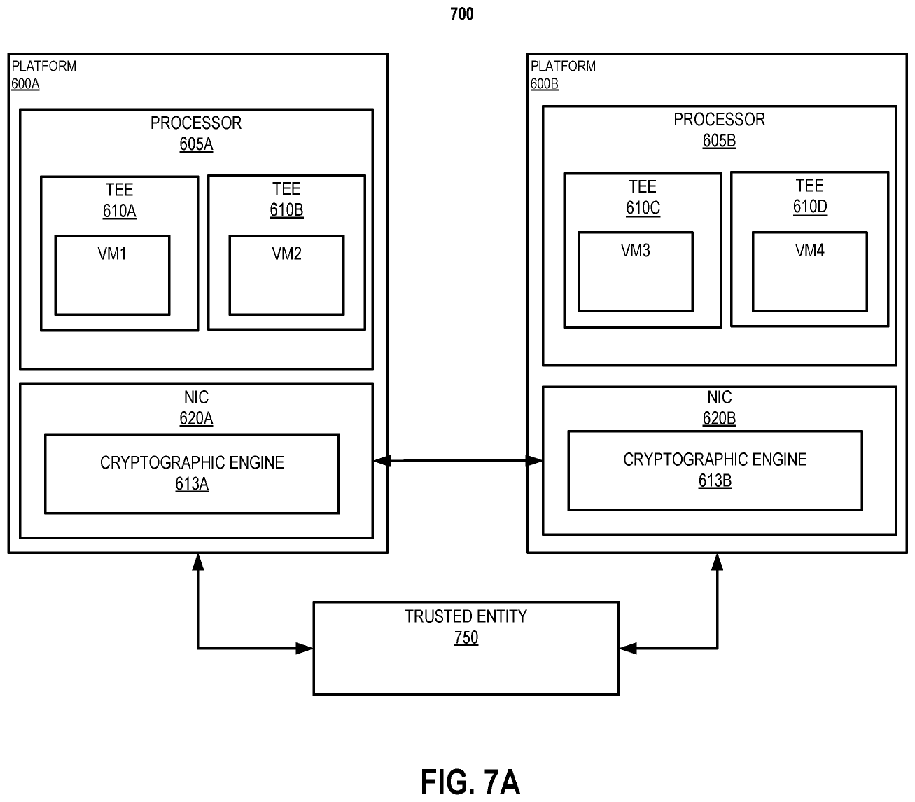

FIG. 6 illustrates a block diagram depicting a platform 600 in accordance with implementations herein. In one implementation, the illustrative platform 600 may include a processor 605 to establish a TEE 610 during operation. The platform 600 may be the same as computing device 100 described with respect to FIGS. 1 and 2, and computing device 400 in FIG. 4, for example. The establishment of the TEE 610 may be in line with the discussion above with respect to FIG. 3 of establishing a TEE and such discussion applies similarly here with respect to FIG. 6.

As illustrated, the TEE 610 further includes an application 614. The various components of the platform 600 may be embodied as hardware, firmware, software, or a combination thereof. As such, in some embodiments, one or more of the components of the platform 600 may be embodied as circuitry or collection of electrical devices. Additionally, in some embodiments, one or more of the illustrative components may form a portion of another component and/or one or more of the illustrative components may be independent of one another.

The TEE 610 may be embodied as a trusted execution environment of the platform 600 that is authenticated and protected from unauthorized access using hardware support of the platform 600. The TEE 610 may also include or otherwise interface with one or more drivers, libraries, or other components of the platform 600 to interface with an accelerator.

Platform 600 also includes a NIC 620, which may be comparable to NIC 150 discussed above. As shown in FIG. 6, NIC 620 includes a cryptographic engine 613 that includes an encryptor/decryptor 615. The cryptographic engine 613 is configured to enable protected data transfer between an application and networked devices via its components. In implementations here, the cryptographic engine 613 is trusted by TEE 610 to enable protected data transfer between an application, such as application 614 operating in TEE 610 and a remote computing platform connected through the network.

The encryptor/decryptor 615 is configured to perform a cryptographic operation associated with a data transfer transaction, such as an RDMA transaction. For an RDMA transaction, the cryptographic operation includes encrypting a data item generated by application 614 to generate an encrypted data item, or decrypting a data item sent to application 614 to generate a decrypted data item.

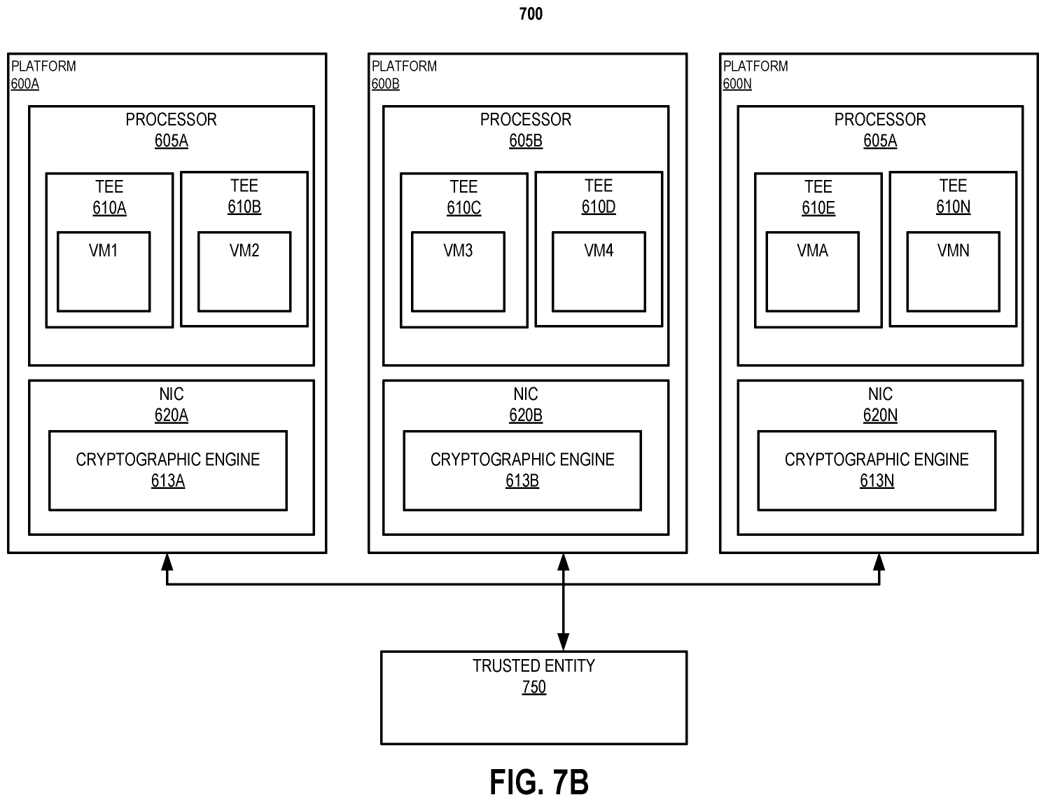

FIGS. 7A & 7B illustrate embodiments of platforms 600 within an overlay network 700. In FIG. 7A, network 700 includes platform 600A coupled to platform 600B. In this embodiment, platform 600A includes TEE 610A and TEE 610B that hosts VM1 and VM2, respectively. Similarly, platform 600B includes a TEE 610C and TEE 610D that hosts VM3 and VM4, respectively. According to one embodiment, each VM may comprise instances of secure enclaves utilized by Intel® Trusted Domain Extensions (TDX) technology.

Additionally, platform 600A includes NIC 620A that is communicably coupled, for example via a network, to NIC 620B within platform 600B. According to one embodiment, each NIC 620 within a platform 600 is coupled to processor 605 (or machine) hosting the VMs, and is trusted by each TEE 610 to isolate and protect its data from other VMs or NIC software clients on a platform 600. For example, NIC 620 communications with VM1 is protected from VM2, and vice versa. Thus, each TEE 610 provides a secure path between its hosted VM and NIC 620. In a further embodiment, a trusted communication channel (e.g., IPsec or TLS) may be established between NIC 620A and NIC 620B to protect data transmitted from VMs 1 and 2 at platform 600A to VMs 3 and 4 at platform 600B. In such an embodiment, cryptographic engines 613 is implemented to encrypt/decrypt data that is transferred between each platform 600. Because each NIC 620 is trusted by each TEE 610, the cryptographic engine 613 within a NIC 620 is permitted to encrypt on behalf of the TEEs 610.

In one embodiment, network 700 includes a trusted entity 750 to establish a trusted communication channel between platform 600A and platform 600B. Trusted entity 750 may be a network orchestrator controller that tracks VMs that are hosted at each platform 600. FIG. 7B illustrates another embodiment of network 700 including platforms 600A-600N coupled via NIC 620A-620 in which each platform 600 is coupled to trusted entity 750.

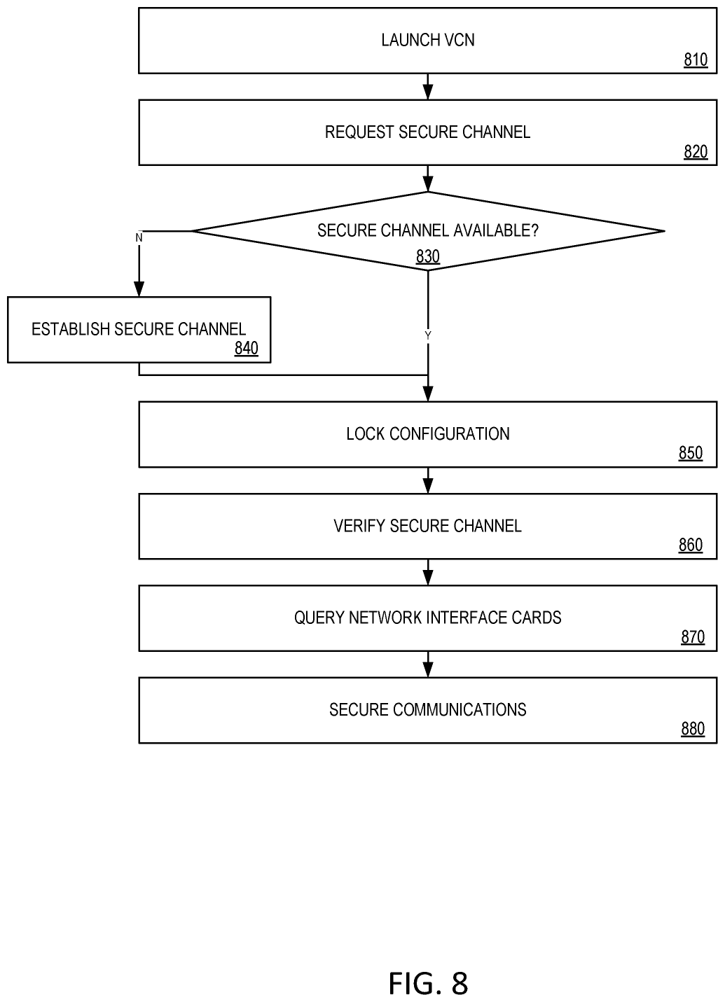

FIG. 8 is a flow diagram illustrating one embodiment of establishing a secure encrypted communication channels (secure channel) between platforms. Prior to commencing secure channel initiation, VMs at platforms 600A and 600B (e.g., VM1 and VM3, respectively) are launched and a VCN (e.g., VNI=100) is established, processing block 810. At processing block 820, a secure channel is requested by the VMs. In one embodiment, VM1 and VM3 each request their local NIC (e.g., via untrusted virtualization software at platforms 600A and 600B) for an IPsec channel. In a further embodiment, VM1 and VM3 may also request for a particular encryption algorithm and strength. The VMs cannot directly request a secure channel, or query whether a secure channel already exists since they are not aware of the physical underlay network and associated IP addresses; the network virtualization software on the platforms is aware of those details.

At decision block 830, a determination is made as to whether a secure channel is currently available (e.g., a channel of equal or greater strength included in the request). If not, a key exchange protocol for IPsec (Internet Key Exchange (IKE)) is initiated between the physical NICs, processing block 840. As mentioned above, each trusted NIC within a platform is used to establish the secure channel via internal cryptographic engines, rather than establishing secure channels via TEE software. In one embodiment, untrusted software operating on platforms 600A and 600B facilitate the exchange of IKE protocol messages between the two respective NICs. As used herein, Internet Key Exchange (IKE) is implemented to establish a secure channel between endpoints to exchange notifications and to negotiate IPsec SAs. IPsec SA specifies security properties that are recognized by communicating hosts.

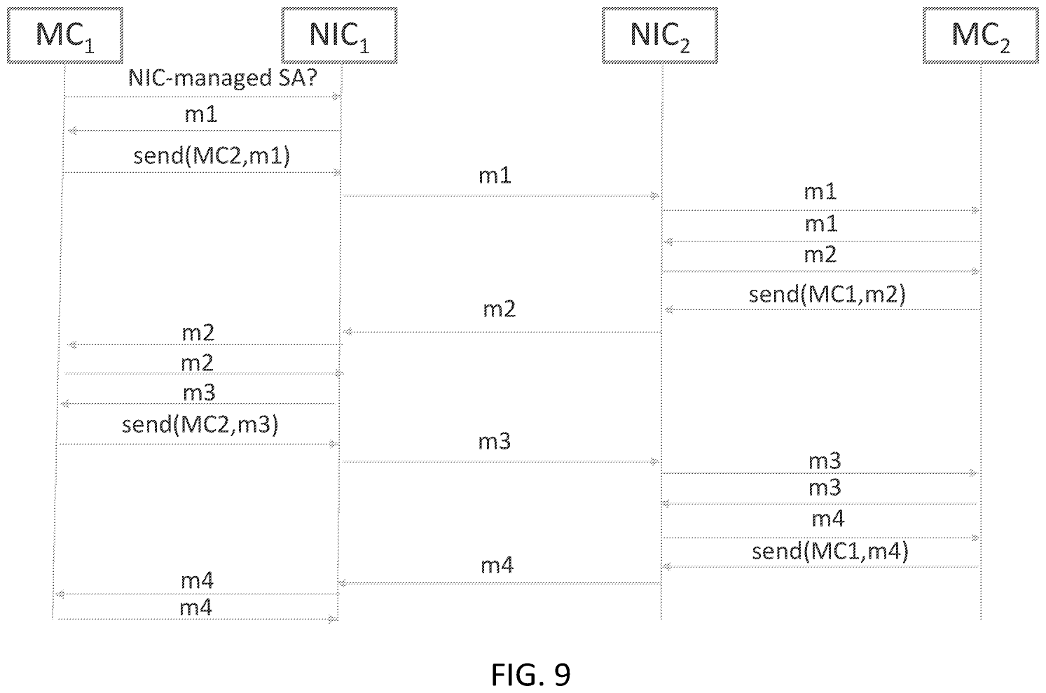

FIG. 9 is a sequence diagram illustrating one embodiment of a process establishing a key exchange between platforms (or machines). As shown in FIG. 9, the protocol begins with one of the hosts querying the local NIC to determine if a NIC-managed IPsec SA exists between the two machines (at the physical underlay network level). If such an IPsec SA exists, the protocol ends and the setup jumps to the next step to verify that IPsec exists. If not, four messages of the IKE protocol are exchanged between the two NICs, with the two machines acting as pass-through agents. In one embodiment, the security-sensitive details of the SA (e.g., encryption keys) are only known to the NICs at the end of the protocol, and not known to the untrusted software MC1 and MC2 on the two machines that facilitated the exchange of the messages. Once the protocol has finished executing, the NICs program their internal Security Policy Database (SPD) and Security Association databases (SADB) with the information about the SA.

Once a secure channel, or a determination at decision block 830 that the secure channel has previously been established (FIG. 8), the TEEs on the VMs lock the configuration (e.g., including TEP entries and IPsec SA) of their respective NICs and are ready to communicate via the VCN, processing block 850. In one embodiment, the VM TEEs cannot verify that an IPsec channel has been established between the platforms because it involved untrusted virtualization software on the two platforms outside of the TEE. Therefore, the two VMs use the trusted entity (orchestrator) to verify that the IPsec channel has been established.

At processing block 860, a VM (e.g., VM1) verifies with the trusted entity whether the secure channel has been established to protect the communication channel between the VM1 virtual IP/MAC addresses and the other VM's (e.g., the VM2 virtual IP/MAC addresses). The trusted entity knows that VM1 is on platform 600A and VM2 is on platform 600B. Thus, at processing block 870, the trusted entity queries the NIC (e.g., via trusted software) on platform 600A to determine the IP address corresponding to the virtual MAC address of VM2, and subsequently provides the IP address to VM1.

In one embodiment, a locked TEP database entry in the platform 600A NIC is used to respond with IP address of the platform 600B NIC. Similarly, the trusted entity queries the NIC on platform 600B to determine the IP address corresponding to the virtual MAC address of VM1, and the locked TEP database entry in the platform 600B NIC is used to respond with its IP address of the platform 600A NIC.

In a further embodiment, the trusted entity subsequently queries NICs on platform 600A and platform 600B to determine whether there is an IPsec SA between Layer 3 endpoints (e.g., the platform 600B NIC and the platform 600B NIC) on the two platforms. The trusted entity may also retrieve information (e.g., encryption algorithm and strength) to pass to the VMs to enable the VMs to confirm whether the IPsec SA exists and has encryption strength equal or stronger than requested. In yet a further embodiment, the trusted entity may be delegated to compare strength requested by VMs and existing IPsec SA strength and return successful securing of connection. The algorithm may be expanded to replace existing weaker SA with stronger SA or add the stronger SA.

At processing block 880, platform 600A and platform 600B may communicate securely using the VCN upon the VMs receiving confirmation from the trusted entity that an IPsec channel exists. In one embodiment, the communication is secured even though VMs share the “outer” IPsec SA because they trust their physical NICs to protect their messages that are multiplexed over the physical interface along with messages from other VMs on those machines. Thus, if another pair of VMs on the two platforms need to communicate securely, the VMs may depend on the NICs to use the same IPsec SA to protect their messages on the untrusted datacenter network. As a result, the two NICs use a single secure communications channel to protect messages between a pair of IP endpoints on the physical network.

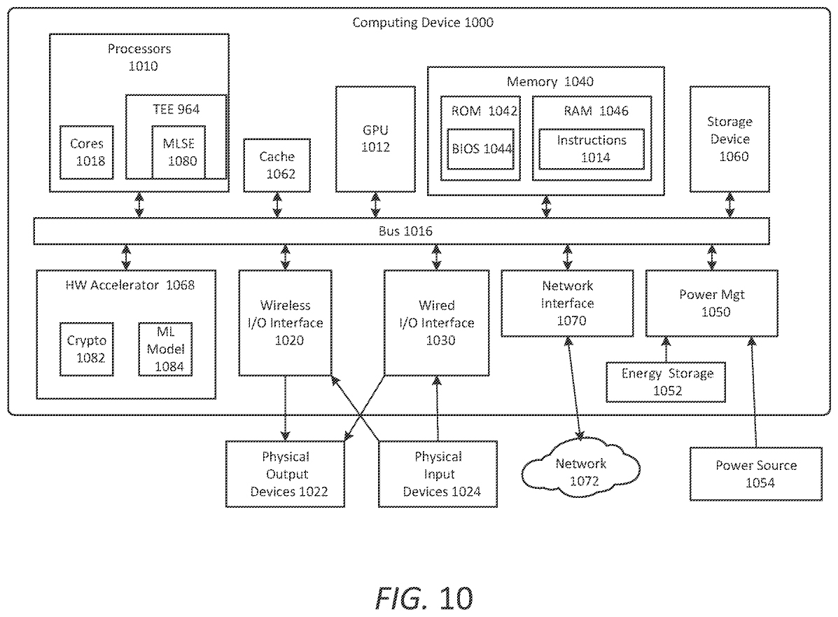

FIG. 10 is a schematic diagram of an illustrative electronic computing device to enable enhanced protection against adversarial attacks according to some embodiments. In some embodiments, the computing device 1000 includes one or more processors 1010 including one or more processors cores 1018 and a Trusted Execution Environment (TEE) 1064, the TEE including a machine learning service enclave (MLSE) 1080. In some embodiments, the computing device 1000 includes a hardware accelerator (HW) 1068, the hardware accelerator including a cryptographic engine 1082 and a machine learning model 1084. In some embodiments, the computing device is to provide enhanced protections against ML adversarial attacks, as provided in FIGS. 1-9.

The computing device 1000 may additionally include one or more of the following: cache 1062, a graphical processing unit (GPU) 1012 (which may be the hardware accelerator in some implementations), a wireless input/output (I/O) interface 1020, a wired I/O interface 1030, memory circuitry 1040, power management circuitry 1050, non-transitory storage device 1060, and a network interface 1070 for connection to a network 1072. The following discussion provides a brief, general description of the components forming the illustrative computing device 1000. Example, non-limiting computing devices 1000 may include a desktop computing device, blade server device, workstation, or similar device or system.

In embodiments, the processor cores 1018 are capable of executing machine-readable instruction sets 1014, reading data and/or instruction sets 1014 from one or more storage devices 1060 and writing data to the one or more storage devices 1060. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 1018 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 1000 includes a bus or similar communications link 1016 that communicably couples and facilitates the exchange of information and/or data between various system components including the processor cores 1018, the cache 1062, the graphics processor circuitry 1012, one or more wireless I/O interfaces 1020, one or more wired I/O interfaces 1030, one or more storage devices 1060, and/or one or more network interfaces 1070. The computing device 1000 may be referred to in the singular herein, but this is not intended to limit the embodiments to a single computing device 1000, since in certain embodiments, there may be more than one computing device 1000 that incorporates, includes, or contains any number of communicably coupled, collocated, or remote networked circuits or devices.

The processor cores 1018 may include any number, type, or combination of currently available or future developed devices capable of executing machine-readable instruction sets.

The processor cores 1018 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 10 are of conventional design. Consequently, such blocks need not be described in further detail herein, as they will be understood by those skilled in the relevant art. The bus 1016 that interconnects at least some of the components of the computing device 1000 may employ any currently available or future developed serial or parallel bus structures or architectures.

The system memory 1040 may include read-only memory (“ROM”) 1042 and random access memory (“RAM”) 1046. A portion of the ROM 1042 may be used to store or otherwise retain a basic input/output system (“BIOS”) 1044. The BIOS 1044 provides basic functionality to the computing device 1000, for example by causing the processor cores 1018 to load and/or execute one or more machine-readable instruction sets 1014. In embodiments, at least some of the one or more machine-readable instruction sets 1014 cause at least a portion of the processor cores 1018 to provide, create, produce, transition, and/or function as a dedicated, specific, and particular machine, for example a word processing machine, a digital image acquisition machine, a media playing machine, a gaming system, a communications device, a smartphone, or similar.

The computing device 1000 may include at least one wireless input/output (I/O) interface 1020. The at least one wireless I/O interface 1020 may be communicably coupled to one or more physical output devices 1022 (tactile devices, video displays, audio output devices, hardcopy output devices, etc.). The at least one wireless I/O interface 1020 may communicably couple to one or more physical input devices 1024 (pointing devices, touchscreens, keyboards, tactile devices, etc.). The at least one wireless I/O interface 1020 may include any currently available or future developed wireless I/O interface. Example wireless I/O interfaces include, but are not limited to: BLUETOOTH®, near field communication (NFC), and similar.

The computing device 1000 may include one or more wired input/output (I/O) interfaces 1030. The at least one wired I/O interface 1030 may be communicably coupled to one or more physical output devices 1022 (tactile devices, video displays, audio output devices, hardcopy output devices, etc.). The at least one wired I/O interface 1030 may be communicably coupled to one or more physical input devices 1024 (pointing devices, touchscreens, keyboards, tactile devices, etc.). The wired I/O interface 1030 may include any currently available or future developed I/O interface. Example wired I/O interfaces include, but are not limited to: universal serial bus (USB), IEEE 1394 (“FireWire”), and similar.

The computing device 1000 may include one or more communicably coupled, non-transitory, data storage devices 1060. The data storage devices 1060 may include one or more hard disk drives (HDDs) and/or one or more solid-state storage devices (SSDs). The one or more data storage devices 1060 may include any current or future developed storage appliances, network storage devices, and/or systems. Non-limiting examples of such data storage devices 1060 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 1060 may include one or more removable storage devices, such as one or more flash drives, flash memories, flash storage units, or similar appliances or devices capable of communicable coupling to and decoupling from the computing device 1000.

The one or more data storage devices 1060 may include interfaces or controllers (not shown) communicatively coupling the respective storage device or system to the bus 1016. The one or more data storage devices 1060 may store, retain, or otherwise contain machine-readable instruction sets, data structures, program modules, data stores, databases, logical structures, and/or other data useful to the processor cores 1018 and/or graphics processor circuitry 1012 and/or one or more applications executed on or by the processor cores 1018 and/or graphics processor circuitry 1012. In some instances, one or more data storage devices 1060 may be communicably coupled to the processor cores 1018, for example via the bus 1016 or via one or more wired communications interfaces 1030 (e.g., Universal Serial Bus or USB); one or more wireless communications interfaces 1020 (e.g., Bluetooth®, Near Field Communication or NFC); and/or one or more network interfaces 1070 (IEEE 802.3 or Ethernet, IEEE 802.11, or Wi-Fi®, etc.).

Processor-readable instruction sets 1014 and other programs, applications, logic sets, and/or modules may be stored in whole or in part in the system memory 1040. Such instruction sets 1014 may be transferred, in whole or in part, from the one or more data storage devices 1060. The instruction sets 1014 may be loaded, stored, or otherwise retained in system memory 1040, in whole or in part, during execution by the processor cores 1018 and/or graphics processor circuitry 1012.

The computing device 1000 may include power management circuitry 1050 that controls one or more operational aspects of the energy storage device 1052. In embodiments, the energy storage device 1052 may include one or more primary (i.e., non-rechargeable) or secondary (i.e., rechargeable) batteries or similar energy storage devices. In embodiments, the energy storage device 1052 may include one or more supercapacitors or ultracapacitors. In embodiments, the power management circuitry 1050 may alter, adjust, or control the flow of energy from an external power source 1054 to the energy storage device 1052 and/or to the computing device 1000. The power source 1054 may include, but is not limited to, a solar power system, a commercial electric grid, a portable generator, an external energy storage device, or any combination thereof.

For convenience, the processor cores 1018, the graphics processor circuitry 1012, the wireless I/O interface 1020, the wired I/O interface 1030, the storage device 1060, and the network interface 1070 are illustrated as communicatively coupled to each other via the bus 1016, thereby providing connectivity between the above-described components. In alternative embodiments, the above-described components may be communicatively coupled in a different manner than illustrated in FIG. 10. For example, one or more of the above-described components may be directly coupled to other components, or may be coupled to each other, via one or more intermediary components (not shown). In another example, one or more of the above-described components may be integrated into the processor cores 1018 and/or the graphics processor circuitry 1012. In some embodiments, all or a portion of the bus 1016 may be omitted and the components are coupled directly to each other using suitable wired or wireless connections.

Illustrative examples of the technologies disclosed herein are provided below. An embodiment of the technologies may include any one or more, and any combination of, the examples described below.

Example 1 includes an apparatus comprising a first computing platform including a processor to execute a first trusted executed environment (TEE) to host a first plurality of virtual machines and a first network interface controller to establish a trusted communication channel with a second computing platform via an orchestration controller

Example 2 includes the subject matter of Example 1, wherein the trusted communication channel is implemented to transfer data between the first plurality of virtual machines to a second plurality of virtual machines hosted at the second computing platform.

Example 3 includes the subject matter of any of Examples 1-2, wherein establishing the trusted communication channel comprises a first virtual machine hosted by the first TEE requesting the first network interface controller to establish an Internet Protocol Security (IPsec) channel between the first computing platform and a second virtual machine hosted by the second computing platform.

Example 4 includes the subject matter of any of Examples 1-3, wherein establishing the trusted communication channel comprises the first TEE locking a configuration of the IPsec channel between the first computing platform and the second computing platform.

Example 5 includes the subject matter of any of Examples 1-4, wherein establishing the trusted communication channel comprises the first virtual machine verifying with the orchestration controller whether the IPsec channel has been established.

Example 6 includes the subject matter of any of Examples 1-5, wherein the first network interface controller comprises a tunneling endpoint (TEP) database to receive a first query from the orchestration controller to determine an internet protocol (IP) address of the second network interface controller at the second computing platform.

Example 7 includes the subject matter of any of Examples 1-6, wherein establishing the trusted communication channel comprises the orchestration controller providing the TP of the second network interface controller to the first virtual machine.

Example 8 includes the subject matter of any of Examples 1-7, wherein establishing the trusted communication channel comprises the first network interface controller to receive a second query from the orchestration controller to determine whether there is an IPsec Security Association (SA) Layer 3 channel between the first network interface controller and the second network interface controller.

Example 9 includes the subject matter of any of Examples 1-8, wherein establishing the trusted communication channel comprises determining that the IPsec channel is not available and establishing the IPsec channel.

Example 10 includes a method comprising a first virtual machine hosted by a first TEE a first computing platform requesting a first network interface controller at the computing platform to establish an Internet Protocol Security (IPsec) channel between the first computing platform and a second virtual machine hosted by a second computing platform, establishing the IPsec channel between the first computing platform and the second computing platform, the first virtual machine verifying with an orchestration controller whether the IPsec channel has been established, receiving an internet protocol (IP) address at the first virtual machine from the orchestration controller associated with a second network interface controller at the second computing platform and transferring data between the first computing platform and the second virtual machine via the IPsec channel.

Example 11 includes the subject matter of Example 10, further comprising the first TEE locking a configuration of the IPsec channel between the first computing platform and the second computing platform.

Example 12 includes the subject matter of any of Examples 10-11, wherein the first virtual machine verifying with the orchestration controller comprises the first network interface controller receiving a first query from the orchestration controller to determine the IP address of the second network interface controller at the second computing platform.

Example 13 includes the subject matter of any of Examples 10-12, wherein the first virtual machine verifying with the orchestration controller further comprises the first network interface controller receiving a second query from the orchestration controller to determine whether there is an IPsec Security Association (SA) Layer 3 channel between the first network interface controller and a second network interface controller.

Example 14 includes a system comprising a first computing platform including a first processor to execute a first trusted executed environment (TEE) to host a first plurality of virtual machines and a first network interface controller to establish a trusted communication channel with a second computing platform, a second computing platform including a second processor to execute a second TEE to host a second plurality of virtual machines and a second network interface controller to establish a trusted communication channel with a second computing platform and an orchestration controller to facilitate a trusted communication channel between the first computing platform and the second computing platform.

Example 15 includes the subject matter of any of Example of Example 14, wherein the trusted communication channel is implemented to transfer data between the first plurality of virtual machines to a second plurality of virtual machines hosted at the second computing platform.

Example 16 includes the subject matter of any of Examples 14-15, wherein establishing the trusted communication channel comprises a first virtual machine hosted by the first TEE requesting the first network interface controller and a second virtual machine hosted by the second TEE to establish an Internet Protocol Security (IPsec) channel between the first computing platform and the second computing platform.

Example 17 includes the subject matter of any of Examples 14-16, wherein establishing the trusted communication channel comprises the first TEE locking a configuration of the IPsec channel between the first computing platform and the second computing platform.

Example 18 includes the subject matter of any of Examples 14-17, wherein establishing the trusted communication channel comprises the first virtual machine verifying with the orchestration controller whether the IPsec channel has been established.

Example 19 includes the subject matter of any of Examples 14-18, wherein the first network interface controller comprises a tunneling endpoint (TEP) database to receive a first query from the orchestration controller to determine an internet protocol (IP) address of the second network interface controller at the second computing platform.

Example 20 includes the subject matter of any of Examples 14-19, wherein establishing the trusted communication channel comprises the orchestration controller providing the TP of the second network interface controller to the first virtual machine.

Example 21 includes at least one computer readable medium having instructions stored thereon, which when executed by one or more processors, cause the processors to request a first network interface controller at the computing platform to establish an Internet Protocol Security (IPsec) channel between the first computing platform and a second computing platform, establish the IPsec channel between the first computing platform and the second computing platform, verify with an orchestration controller whether the IPsec channel has been established, receive an internet protocol (IP) address from the orchestration controller associated with a second network interface controller at the second computing platform and transfer data between the first computing platform via the IPsec channel.

Example 22 includes the subject matter of any of Example of Example 21, having instructions stored thereon, which when executed by one or more processors, further cause the processors to locking a configuration of the IPsec channel between the first computing platform and the second computing platform.

Example 23 includes the subject matter of any of Examples 21-22, wherein verifying with the orchestration controller comprises the first network interface controller receiving a first query from the orchestration controller to determine the IP address of the second network interface controller at the second computing platform.

Example 24 includes the subject matter of any of Examples 21-23, wherein verifying with the orchestration controller further comprises the first network interface controller receiving a second query from the orchestration controller to determine whether there is an IPsec Security Association (SA) Layer 3 channel between the first network interface controller and a second network interface controller.

Example 25 includes a system comprising an orchestration controller to facilitate a trusted communication channel between the first computing platform and the second computing platform.

Example 26 includes the subject matter of any of Example of Example 25 wherein the orchestration controller receives a request from the first computing platform to verify whether an Internet Protocol Security (IPsec) channel has been established between the first computing platform and the second computing platform.

Example 27 includes the subject matter of any of Examples 25-26, wherein the orchestration controller queries a network interface controller within the from the first computing platform to determine an internet protocol (IP) address of a second network interface controller at the second computing platform.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition, “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a first computing platform including:
a processor to execute a first trusted executed environment (TEE) to host a first plurality of virtual machines; and
a first network interface controller to establish a trusted communication channel with a second computing platform via an orchestration controller.

2. The apparatus of claim 1, wherein the trusted communication channel is implemented to transfer data between the first plurality of virtual machines to a second plurality of virtual machines hosted at the second computing platform.

3. The apparatus of claim 2, wherein establishing the trusted communication channel comprises a first virtual machine hosted by the first TEE requesting the first network interface controller to establish an Internet Protocol Security (IPsec) channel between the first computing platform and a second virtual machine hosted by the second computing platform.

4. The apparatus of claim 3, wherein establishing the trusted communication channel comprises the first TEE locking a configuration of the IPsec channel between the first computing platform and the second computing platform.

5. The apparatus of claim 4, wherein establishing the trusted communication channel comprises the first virtual machine verifying with the orchestration controller whether the IPsec channel has been established.

6. The apparatus of claim 5, wherein the first network interface controller comprises a tunneling endpoint (TEP) database to receive a first query from the orchestration controller to determine an internet protocol (IP) address of the second network interface controller at the second computing platform.

7. The apparatus of claim 6, wherein establishing the trusted communication channel comprises the orchestration controller providing the IP address of the second network interface controller to the first virtual machine.

8. The apparatus of claim 7, wherein establishing the trusted communication channel comprises the first network interface controller to receive a second query from the orchestration controller to determine whether there is an IPsec Security Association (SA) Layer 3 channel between the first network interface controller and the second network interface controller.

9. The apparatus of claim 3, wherein establishing the trusted communication channel comprises determining that the IPsec channel is not available and establishing the IPsec channel.

10. A method comprising:
a first virtual machine hosted by a first TEE at a first computing platform requesting a first network interface controller at the computing platform to establish an Internet Protocol Security (IPsec) channel between the first computing platform and a second virtual machine hosted by a second computing platform;
establishing the IPsec channel between the first computing platform and the second computing platform;
the first virtual machine verifying with an orchestration controller whether the IPsec channel has been established;
receiving an internet protocol (IP) address at the first virtual machine from the orchestration controller associated with a second network interface controller at the second computing platform; and
transferring data between the first computing platform and the second virtual machine via the IPsec channel.

11. The method of claim 10, further comprising the first TEE locking a configuration of the IPsec channel between the first computing platform and the second computing platform.

12. The method of claim 11, wherein the first virtual machine verifying with the orchestration controller comprises the first network interface controller receiving a first query from the orchestration controller to determine the IP address of the second network interface controller at the second computing platform.

13. The method of claim 12, wherein the first virtual machine verifying with the orchestration controller further comprises the first network interface controller receiving a second query from the orchestration controller to determine whether there is an IPsec Security Association (SA) Layer 3 channel between the first network interface controller and a second network interface controller.

14. At least one computer readable medium having instructions stored thereon, which when executed by one or more processors, cause the processors to:
request a first network interface controller at the computing platform to establish an Internet Protocol Security (IPsec) channel between the first computing platform and a second computing platform;
establish the IPsec channel between the first computing platform and the second computing platform;
verify with an orchestration controller whether the IPsec channel has been established;
receive an internet protocol (IP) address from the orchestration controller associated with a second network interface controller at the second computing platform; and
transfer data between the first computing platform via the IPsec channel.

15. The computer readable medium of claim 14, having instructions stored thereon, which when executed by one or more processors, further cause the processors to locking a configuration of the IPsec channel between the first computing platform and the second computing platform.

16. The computer readable medium of claim 15, wherein verifying with the orchestration controller comprises the first network interface controller receiving a first query from the orchestration controller to determine the IP address of the second network interface controller at the second computing platform.

17. The computer readable medium of claim 16, wherein verifying with the orchestration controller further comprises the first network interface controller receiving a second query from the orchestration controller to determine whether there is an IPsec Security Association (SA) Layer 3 channel between the first network interface controller and a second network interface controller.

18. A system comprising an orchestration controller to facilitate a trusted communication channel between the first computing platform and the second computing platform.

19. The system of claim 18, wherein the orchestration controller receives a request from the first computing platform to verify whether an Internet Protocol Security (IPsec) channel has been established between the first computing platform and the second computing platform.

20. The system of claim 19, wherein the orchestration controller queries a network interface controller within the from the first computing platform to determine an internet protocol (IP) address of a second network interface controller at the second computing platform.
